(19) United States
(12) Patent Application Publication
(10) Pub. No.: US 2016/0200483 A1
(43) Pub. Date: Jul. 14, 2016

(54) PET WASTE BAG WINDING PACKAGING PLACING STRUCTURE

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 14/996,156

(22) Filed: Jan. 14, 2016

(30) Foreign Application Priority Data
Jan. 14, 2015 (CN) 201520025457.8

(51) Int. Cl. B65D 33/00; A01K 29/00; B65H 18/28; A01K 1/01

(52) U.S. Cl. CPC B65D 33/002; A01K 1/01; A01K 29/00; B65H 18/28

(57) ABSTRACT

A pet waste bag winding packaging structure includes a plurality of rectangular pet waste bags, wherein a length of a rectangular pet waste bag in the winding direction is a, wherein the plurality of rectangular pet waste bags are arranged in a sequence along a length direction, wherein each pair of neighboring rectangular pet waste bags in the sequence partially overlap with each other, and wherein an overlapped length is b, and b equals 0.5-0.2 a.

### CROSS-REFERENCE TO RELATED APPLICATIONS

This application claims the priority of Chinese Patent Application No. CN201520025457.8, filed on Jan. 14, 2015, the disclosure of which is incorporated by reference in its entirety.

### TECHNICAL FIELD

The invention relates to structures for an accessory article for pets, and more particularly, to a placing/storage structure for waste bags for use in pet waste bag winding packaging.

### BACKGROUND ART

A waste bag, as the name implies, is a bag for holding wastes. A small bag brings more conveniences for thousands of households, also provides important guarantee for environment protection, and even is beneficial for recycling and categorizing/classifying different wastes.

Pet wastes mainly refer to feces. The defecation of pets anywhere in outdoors affects the environment and hygiene, and is prone to spread diseases. Therefore, the pet owners shall collect the wastes into a waste bag in time and then put them into a garbage box.

A pet waste bag is a rectangular plastic bag. The present manufacturing and packaging manners and structures are that the waste bags are connected end to end and arranged continuously, wherein perforations are made between the waste bags using a toothed cutter. The waste bags are wound into a cylinder from beginning to end and placed in a corresponding elongated rectangular box. Because the waste bags are wide, some waste bags are folded in trifold in the width direction to reduce the width so that the waste bags are conveniently wound and packaged, and convenient to use. When in use, the waste bags are drawn out from the open slot of the rectangular box and torn off along the perforations, wherein the action of tearing would required the use of two hands, one hand for tearing off a bag and the other for holding the waste bags in a roll. Such a packaging structure is inconvenient for a pet owner to tear off the waste bag using only one hand, when the pet owner holds the pet by the other hand or carries the pet in arms. For this reason, the pet owner may possibly skip clearing the pet wastes, resulting in undersirable impact on the environment. Therefore, it is desirable to have a waste bag holding/storing structure/device, which is convenient to take out the waste bag by using a single hand.

### SUMMARY OF THE INVENTION

An object of the invention is to provide a pet waste bag winding packaging holding device (structure) capable of allowing convenient dispensing of a waste bag from an elongated rectangular box, which remedies some foregoing defects in the prior art.

An object of the invention may be realized with the following technical features/embodiments.

A pet waste bag winding packaging structure (i.e., a roll of pet waste bag),

Assuming a length of a rectangular pet waste bag in the winding direction is a, a device/structure of the invention is characterized in that:

a plurality of rectangular pet waste bags are arranged in sequence (in a series) along the length direction and the waste bags partially overlap with each other, wherein the overlapped length is b, and the length b equals 0.5-0.2 a.

By employing the technical features of the invention, a plurality of rectangular pet waste bags are arranged in sequence along the length direction, wound into a roll, and then placed into an elongated rectangular box. When in use, a waste bag is drawn out from the open slot of the rectangular box, wherein the bags are not entangled or connected with each other and can be taken out by using a single hand, while the overlapped parts can bring out the subsequent bag when pulling the prior waste bag, leaving the opening end of the latter/subsequent waste bag exposed to facilitate subsequent taking and using.

In preferred embodiments, the length b i equals 0.25 a.

In preferred embodiments, a diameter of the cylinder, formed by arranging and winding the rectangular pet waste bags, is 25-35 mm, and the width (length) of the cylinder is 55-65 mm.

In preferred embodiments, the diameter of the cylinder formed by arranging and winding the rectangular pet waste bags is 32 mm, and the width of the cylinder is 61 mm.

In preferred embodiments. the rectangular pet waste bag is a thin plastic bag.

Embodiments of the invention have the advantageous effects that embodiments of the invention the invention overcome the defects of inconvenient taking and using of pet waste bags from a winding packaging structure of the prior art, pet waste bags arranged and wound in accordance with embodiments of the invention can be conveniently taken and used with a single hand, is beneficial for a pet owner to clean wastes (such as pet feces) in time, and is beneficial for keeping a clean and healthy environment.

### BRIEF DESCRIPTION OF THE DRAWINGS

FIG. 1 shows a structural placing diagram showing a pet waste bag winding packaging placing structure according to one implementation of the invention;

FIG. 2 shows a top view of a single pet waste bag, wherein the left side of the view shows an open portion of the pet waste bag, the right side shows a bonding and sealing portion of the pet waste bag, and the length is displayed as a;

FIG. 3 shows a schematic illustrating the winding packaging of pet waste bags in the prior art, wherein the waste bags are connected end to end and arranged continuously, and perforations is made between the waste bags using a toothed cutter;

FIG. 4 shows a schematic illustrating the winding the pet waste bag in the width direction and folding of the bag in trifold;

FIG. 5 shows a structural state diagram showing pet waste bag winding and packaging in accordance with one embodiment of the invention, wherein a plurality of rectangular pet waste bags are arranged in sequence along the length direction, and partially overlap with each other to wind into a cylinder; and

FIG. 6 shows a structural state diagram illustrating the pet waste bag winding and packaging, which is wound into a cylinder/roll, in accordance with one embodiment of the invention.

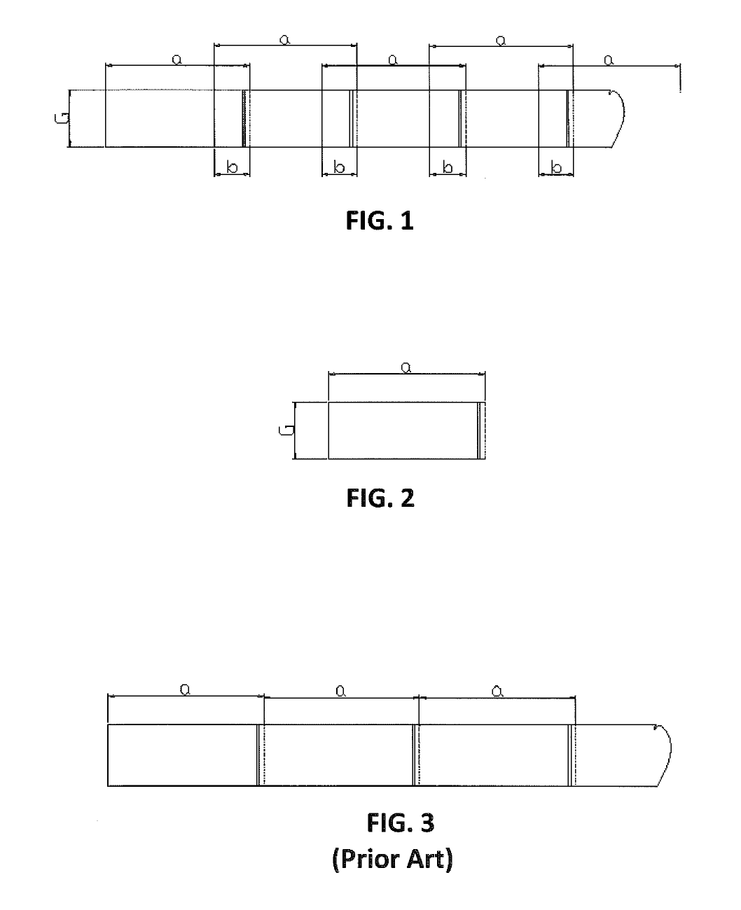

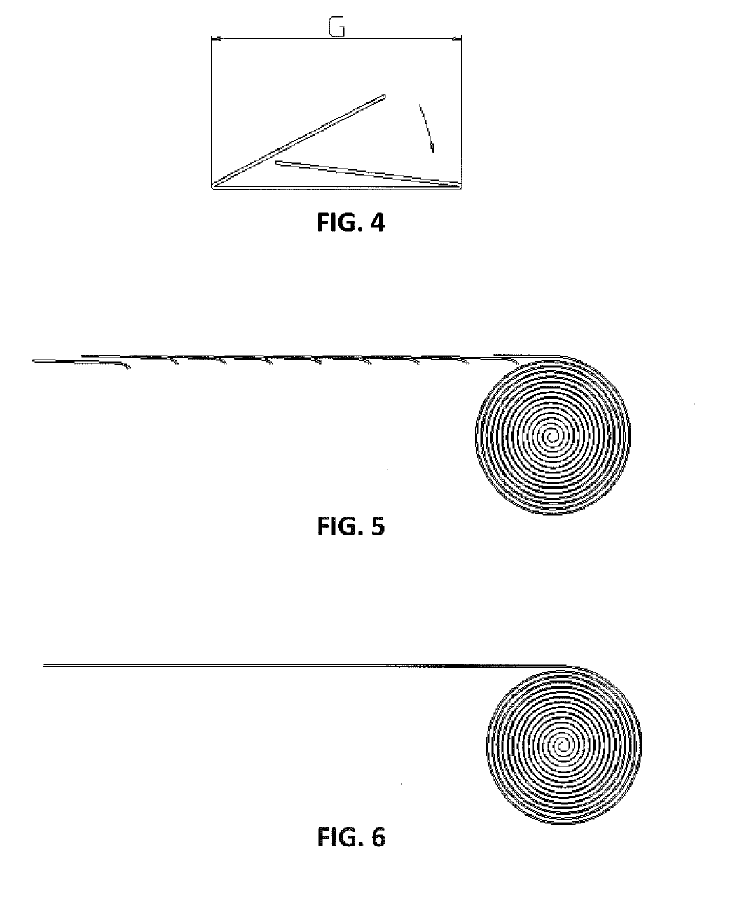

In the figures: a refers to the length of the rectangular pet waste bag on the winding direction, b refers to the overlapped length of the pet waste bags, and G refers to the length (width) of the pet waste bag winded in the width direction and folded in trifold, which is also the width of the wound cylinder.

### DETAILED DESCRIPTION

Embodiments of the invention relate to pet waste bags rolled up in specific manners/structures to facilitate use of such bags. These structures may be referred to as pet waste bag winding packaging structures or rolls. The structures and processes in accordance with embodiments of the invention will be further explained in details with reference to the accompanying drawings hereinafter.

A pet waste bag winding packaging structure (or roll) has the following features:

wherein a length of a rectangular pet waste bag in the winding direction is a, wherein a plurality of rectangular pet waste bags are arranged in a sequence and partially overlap with each other before winding (or rolled up) into a cylinder, wherein an overlapped length is b and b equals 0.5-0.2 a. The pet waste bags are wound into a cylinder and may be placed into a rectangular box; a opening/slot may be arranged at a side edge of the rectangular box in the length direction so as to allow removal of a pet waste bag for use and for pulling out a subsequent pet waste bag to expose the subsequent pet waste bag. Such a “removal slot/opening” is commonly known in similar arts, such as the slot on a tissue box.

In some embodiments, the length b is equal to 0.25 a. Such an overlapped length does not interfere with the drawing out (removing) of the former bag, and is sufficient to bring out (by static or friction force) an end portion of the subsequent pet waste bag to expose a portion of the subsequent bag to facilitate the next pulling.

In some embodiments, a diameter of the cylinder, formed after arranging and winding of the rectangular pet waste bags, is about 25-35 mm, and a width of the cylinder is about 55-65 mm. As described above, embodiments of the invention can be convenient carried and used by a pet owner for clearing pet feces in time.

In preferred embodiments, the diameter of the cylinder winded, after arranging and winding the rectangular pet waste bags, is about 32 mm, and the width of the cylinder is about 61 mm, which are more suitable sizes for use.

In preferred embodiments, the rectangular pet waste bag is a thin plastic bag, which is suitable for mass production and use.

While embodiments of the invention have been described with limited examples, one skilled in the art would appreciate that other modifications or variations are possible without departing from the scope of the invention. Therefore, the scope of protection should be based on the accompanying claims.

What is claimed is:

1. A pet waste bag winding packaging structure, comprising a plurality of rectangular pet waste bags,
wherein a length of a rectangular pet waste bag in the winding direction is a,
wherein the plurality of rectangular pet waste bags are arranged in a sequence along a length direction,
wherein each pair of neighboring rectangular pet waste bags in the sequence partially overlap with each other, and
wherein an overlapped length is b, and b equals 0.5-0.2 a.

2. The pet waste bag winding packaging structure according to claim 1, wherein the overlap length b equals 0.25 a.

3. The pet waste bag winding packaging structure according to claim 1, wherein a diameter of a cylinder formed by arranging and winding the plurality of rectangular pet waste bags is 25-35 mm, and a length of the cylinder is 55-65 mm.

4. The pet waste bag winding packaging placing structure according to claim 3, wherein the diameter of the cylinder is about 32 mm, and the width of the cylinder is about 61 mm.

5. The pet waste bag winding packaging placing structure according to claim 1, wherein the plurality of rectangular pet waste bags are thin plastic bags.
